(19) United States
(12) Patent Application Publication
(10) Pub. No.: US 2020/0384457 A1
(43) Pub. Date: Dec. 10, 2020

(54) FLUID EJECTION DEVICES WITH MANUAL ADJUSTMENT DEVICES

(71) Applicant: HEWLETT-PACKARD DEVELOPMENT COMPANY, L.P., Spring, TX (US)

(72) Inventors: Dennis R. Esterberg, Corvallis, OR (US); Christie Dudenhoefer, Corvallis, OR (US); Kenneth Duda, Corvallis, OR (US); Ed M. Grenier, Corvallis, OR (US); David H. Ochs, Corvallis, OR (US); Joshua M. Yu, Corvallis, OR (US); Matthew David Smith, Corvallis, OR (US)

(73) Assignee: HEWLETT-PACKARD DEVELOPMENT COMPANY, L.P., Spring, TX (US)

(21) Appl. No.: 16/766,606

(22) PCT Filed: Jan. 30, 2018
(86) PCT No.: PCT/US2018/015828

§ 371 Date: May 22, 2020

(51) Int. Cl. B01L 3/02

(52) U.S. Cl. CPC B01L 3/0268; B01L 2400/0487; B01L 2400/02

(57) ABSTRACT

In one example in accordance with the present disclosure, a fluid ejection device is described. The fluid ejection device includes a vertical support and an interface movably coupled to the vertical support. The interface is to receive an ejection head. The fluid ejection device also includes a manual adjustment device associated with the interface to adjust a distance between the interface and a substrate stage.

### BACKGROUND

An assay is a process used in laboratory medicine, pharmacology, analytical chemistry, environmental biology, and molecular biology to assess or measure the presence, amount, or functional activity of a sample. The sample may be a drug, a genomic sample, a proteomic sample, a biochemical substance, a cell in an organism, an organic sample, or other inorganic and organic chemical samples. In general, an assay is carried out by dispensing small amounts of fluid into multiple wells of a titration plate. The fluid in these wells can then be processed and analyzed. Such assays can be used to enable drug discovery as well as facilitate genomic and proteomic research.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a fluid ejection device with a manual adjustment device, according to an example of the principles described herein.

FIG. 2 is a block diagram of a fluid ejection system including a fluid ejection device with a manual adjustment device, according to an example of the principles described herein.

FIG. 3 is an isometric view of the fluid ejection system with the interface in a raised position and a set screw adjustment device, according to an example of the principles described herein.

FIG. 4 is an isometric view of the fluid ejection system with the interface in a lowered position and a set screw adjustment device, according to an example of the principles described herein.

FIG. 5 is an isometric view of the fluid ejection system with a set screw adjustment device and preset position indicators, according to an example of the principles described herein.

FIG. 6 is an isometric view of the fluid ejection system with a motor and gear set adjustment device, according to an example of the principles described herein.

FIG. 7 is an isometric view of the fluid ejection system with pneumatic adjustment device, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An assay is a process used in laboratory medicine, pharmacology, analytical chemistry, environmental biology, and molecular biology to assess or measure the presence, amount, or functional activity of a sample. The sample may be a drug, a genomic sample, a proteomic sample, a biochemical substance, a cell in an organism, an organic sample, or other inorganic and organic chemical samples. In general, an assay is carried out by dispensing small amounts of fluid into multiple wells of a titration plate. The fluid in these wells can then be processed and analyzed. Such assays can be used to enable drug discovery as well as facilitate genomic and proteomic research.

Such assays have been performed manually. That is, a user fills fluid into a single channel pipette, or a multi-channel pipette, and manually disperses a prescribed amount of fluid from the pipette into various wells of a titration plate. As this process is done by hand, it is tedious, complex, and inefficient. Moreover, it is prone to error as a user may misalign the pipette with the wells of the titration plate and/or may dispense an incorrect amount of fluid. Still further, such manual deposition of fluid may be incapable of dispensing low volumes of fluid, for example in the picoliter range.

In some examples however, digital dispensing of fluid is replacing manual dispensing methods. In these examples, high precision digital fluid ejection devices, referred to herein as fluidic dies, are used. A fluidic die includes a number of ejection subassemblies. Each ejection subassembly holds a small volume of fluid and an actuator expels that fluid through an opening. In operation, the fluidic dies dispense the fluid onto a substrate, such as into wells of a titration plate positioned below the fluidic dies. A fluidic ejection system holds the fluidic dies and the substrate. This fluidic ejection system controls fluid ejection from the fluidic dies onto the substrate. As part of this, the fluidic ejection system may properly position the fluidic dies with respect to the substrate by moving either the fluidic dies or the substrate.

While fluidic die have undoubtedly advanced digital titration, some characteristics impede their more complete implementation. For example, certain fluid ejection systems include laser sensors to determine a height between the ejection heads disposed in the fluidic ejection system and the substrate onto which the fluid is ejected. Automated devices then adjust the height of the substrate while the ejection head remains stationary. Such automated equipment can be complex to both manufacture and operate. For example, the height between the substrate and an ejection head is carefully maintained in order to ensure that the fluid lands in the intended location on the substrate. Such precision can be difficult to control.

Accordingly, the present specification describes a fluidic ejection system that addresses these and other issues. Specifically, the present specification describes a fluidic ejection device and system that include a manual adjustment device to move the ejection head that is inserted into the fluid ejection device relative to the substrate and substrate stage.

Specifically, the present specification describes a fluid ejection device. The fluid ejection device includes a vertical support and an interface movably coupled to the vertical support. The interface receives an ejection head. The fluid ejection device also includes a manual adjustment device associated with the interface to adjust a distance between the interface and a substrate stage.

The specification also describes a fluid ejection system. The fluid ejection system includes a base and a substrate stage movably coupled to the base. The fluid ejection system also includes a fluid ejection device with its corresponding vertical support, interface, and manual adjustment device.

Still further, the specification also describes another example of the fluid ejection system that includes the base, substrate stage, the substrate disposed on the stage, as well as the fluid ejection device.

As used in the present specification and in the appended claims, the term “fluidic die” refers to a component that ejects fluid and includes a number of ejection subassemblies.

Accordingly, as used in the present specification and in the appended claims, the term “ejection subassembly” refers to an individual component of a fluidic die that ejects fluid onto a surface. The ejection subassembly may be referred to as a nozzle and includes at least an ejection chamber to hold an amount of fluid and an opening through which the fluid is ejected. In some examples, the ejection subassembly includes an actuator disposed within the ejection chamber.

Further, as used in the present specification and in the appended claims, the term “ejection head” refers to a component received in a fluidic ejection device that includes multiple fluidic die. In one example, an ejection head may be removably inserted into a fluidic ejection device. In another example, the ejection head may be integrated into the fluidic ejection device.

Accordingly, as used in the present specification and in the appended claims, the term “fluid ejection device” refers to a device that receives the ejection head and includes the vertical support that moves and the manual adjustment device. Specifically, an “interface” of the fluid ejection device receives the ejection head. That is, the “interface” is a component of the fluid ejection device.

As used in the present specification and in the appended claims, the term “fluid ejection system” refers to the fluidic ejection device as well as the substrate stage on which a substrate is disposed.

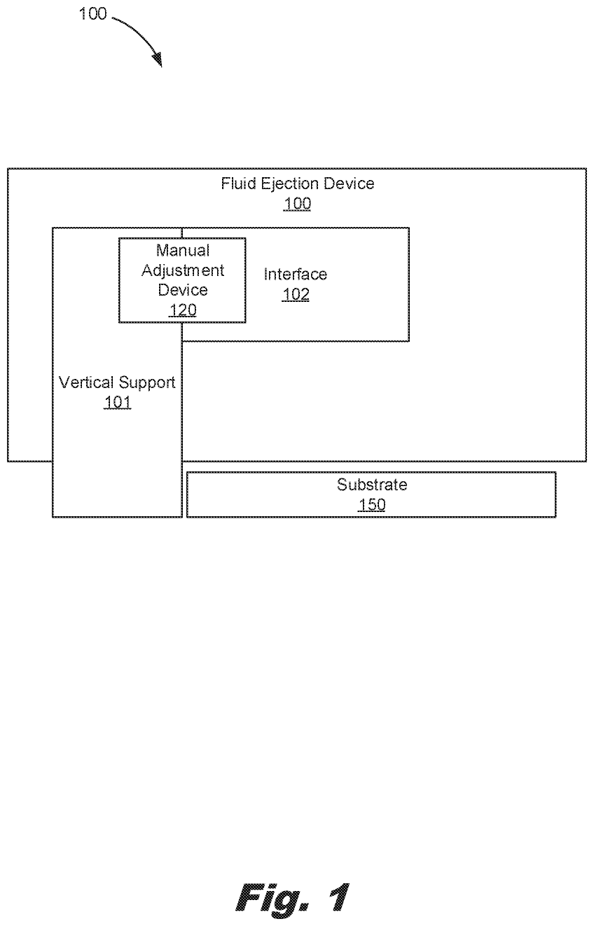

Turning now to the figures, FIG. 1 is a block diagram of a fluid ejection device (100) with a manual adjustment device (120), according to an example of the principles described herein. The fluid ejection device (100) may be part of an overall fluid ejection system used to dispense fluid onto a substrate (150). For example, the fluid ejection system may dispense fluid into wells of a titration plate. The fluid dispensed by the fluid ejection device (100) may be of a variety of types. For example, the fluid ejection device (100) may dispense solvent or aqueous-based pharmaceutical compounds and aqueous-based biomolecules including, for example, proteins, enzymes, lipids, mastermix, DNA samples, among others, into wells of a titration plate or onto other types of substrates (150). Such fluid ejection systems may be used in titration processes, compound secondary screening, enzyme profiling, and polymerase chain reactions (PCR), among other chemical and biochemical reactions.

The fluid ejection device (100) includes a vertical support (101) and an interface (102) movably coupled to the vertical support (101). The interface (102) may move using any mechanism including, for example, a number of mating rails with one half of the mating rails being coupled to the vertical support (101) and the other half of the mating rails being coupled to the interface (102).

The fluid ejection device (100) also includes a manual adjustment device (120) associated with the interface (102) to adjust the distance between the interface (102) a substrate (150), which substrate (150) may be disposed on a substrate stage. The manual adjustment device (120) may include any number of non-automated components such as, for example a set screw—with or without preset position indicators, a shim, a motor and gear set, and a pneumatic device to move the interface (102) relative to the substrate (150)/substrate stage. The manual adjustment device (120) may include other components to aid in such movement including a graphical user interface (GUI) and a toggle switch. The inclusion of the manual adjustment device (120) reduces the cost in manufacturing and parts within the fluid ejection device (100) and the system of which it is a component.

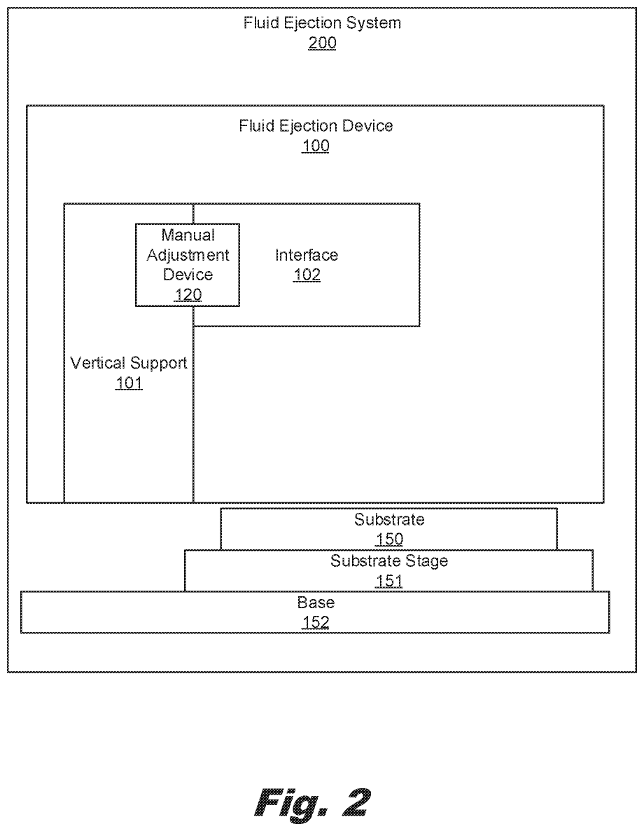

FIG. 2 is a block diagram of a fluid ejection system (200) that includes a fluid ejection device (100) with a manual adjustment device (120), according to an example of the principles described herein. The fluid ejection system (200) includes the fluid ejection device (100) with its corresponding interface (102), vertical support (101), and manual adjustment device (120). The fluid ejection system (200) also includes a base (152) to hold the fluid ejection device (100). In some examples, the vertical support (101) extends from the base (152) and is movable in an x, y, and z direction relative to the base (152).

The fluid ejection system (200) also includes a substrate stage (151) that is movably coupled to the base (152). The substrate stage (151) moves as instructed by a processing device in order to place the substrate (150) into a desired position underneath the ejection head which is disposed within the interface (102).

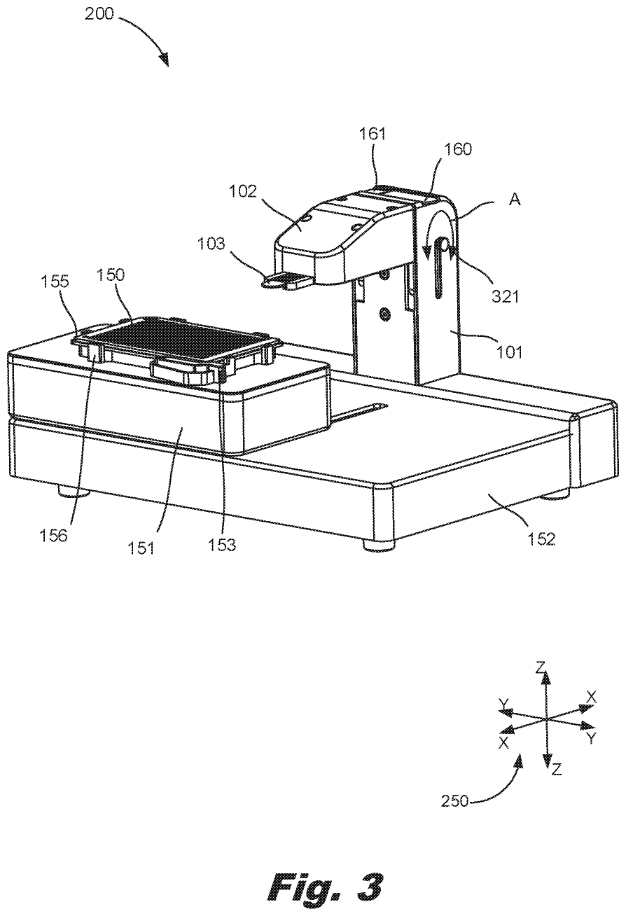

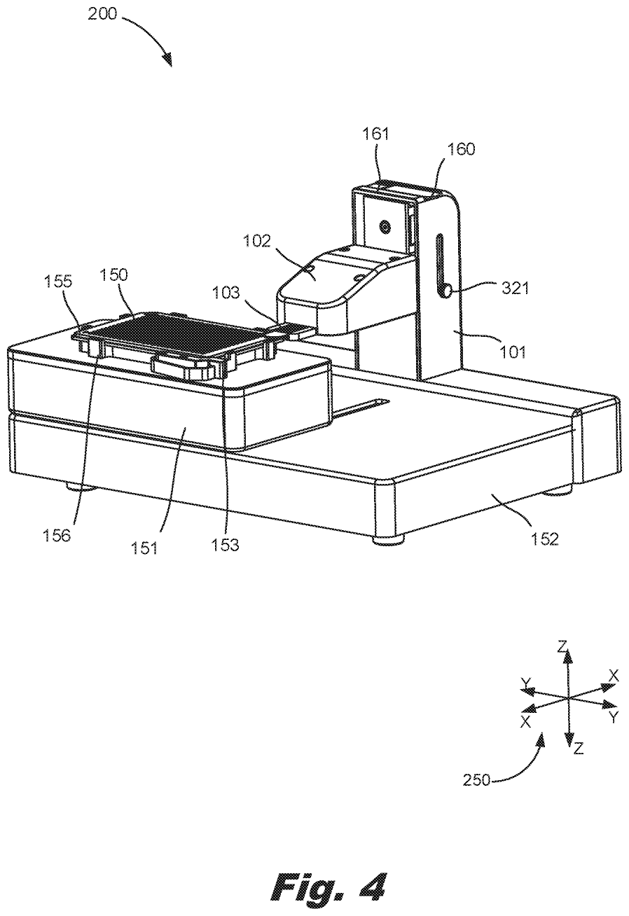

FIGS. 3 and 4 are isometric views of the fluid ejection system (200) with the interface (102) in a raised position and a lowered position and a set screw (321) adjustment device, according to an example of the principles described herein. Specifically, FIG. 3 is an isometric view with the interface (102) in a raised position and FIG. 4 is an isometric view with the interface (102) in a lowered position. As described above, the fluid ejection system (200) includes a base (152) and a substrate stage (151) movably coupled to the base (152). That is, the substrate stage (151) may move relative to the base in an X and Y direction as indicated by the coordinate indicator (250). Such movement allows the ejection head (103) to align with, and deposit fluid onto different portions of the substrate (150).

The substrate stage (151) refers to a component that retains the substrate (150), which as depicted in FIG. 3, may be a titration plate. However, any other type of substrate (150) may be retained in the substrate stage (151). The substrate stage (151) includes a mount (155) to retain the substrate (150) in a fixed position relative to the substrate stage (151). In this manner, the substrate (150) is secured to the substrate stage (151) and remains in place during movement of the substrate stage (151) relative to the base (152) when fluid from the ejection head (103) is dispensed onto the various portions of the substrate (150). In one example, the substrate mount (155) may include a number of locating features (156) to couple the substrate (150) to the substrate stage (151) via the substrate mount (155). While FIG. 3 depicts a single locating feature (156), the mount (155) may include any number of locating features (156) to retain the substrate (150) to the stage (151). In some examples, the mount (155) also includes a spring-loaded retention device (153). That is, prior to insertion of the substrate (150) into the mount (155), the spring-loaded retention device (153) may be deflected to allow the substrate (150) to be positioned on the mount (155) via the locating features (156). Once in place, the spring mechanism of the spring-loaded retention device (153) engages to press against the substrate (150), thus keeping it in place.

Turning to the substrate (150), the substrate (150) may be any material on which fluid may be dispensed. In one example, the substrate (150) may be a titration plate with a number of wells in an array. Such a titration plate may be between approximately 4 and 50 millimeters thick. While specific reference is made to a particular substrate (150) thickness. The fluid ejection device (100) may be used with substrates (150) having a wide variety of thicknesses.

Note that while FIG. 3 depicts a titration plate as a specific example of a substrate (150), the substrate (150) may be any surface on which fluid may be deposited including, for example, a microscope slide, an edible wafer, or any other substrate. As the interface (102) is adjustable in the z direction as indicated by the coordinate indicator (250), the fluid ejection system (200) can accommodate a wide variety of substrates and media having different thicknesses.

The interface (102) provides an electrical interface to an ejection head (103). The ejection head (103) may include a number of fluidic die on a bottom surface and a number of reservoirs on a top surface to deliver fluid to the fluidic dies. A fluidic die may include a plurality of ejection subassemblies used to eject fluid from the fluidic die. The fluidic dies may be discrete MEMSs (Micro-Electro-Mechanical Systems) where each fluidic die dispenses drops of between approximately 1.0 picoliters and 500 picoliters. The reservoirs are open at the top to receive fluid, for example from a pipette, and may have a narrower opening at the bottom to deliver the fluid to respective fluidic die on the bottom of the ejection head (103). In some examples, the ejection head (102) is removable from the fluid ejection system (200) for example as a replaceable cassette. In other examples, the ejection head (102) is integrated with the fluid ejection system (200).

As described above, in order to accommodate substrates (150) of different thicknesses and in order to bring the interface (102) into a desired position close to the substrate (150) to effectively deliver fluid to the substrate (150), the interface (102) may be manually adjusted in the z direction using a manual adjustment device (FIG. 1, 120). In the example depicted in FIGS. 3 and 4, the manual adjustment device (FIG. 1, 120) is a set screw (321).

Disengagement of the set screw (321) un-fixes the interface (102) from the vertical support (101), such that the interface (102) is movable along the vertical support (101). Engagement of the set screw (321) holds the interface (102) in a fixed position relative to the vertical support (101). The engagement and disengagement of the set screw (321) may be effectuated by loosening and tightening the set screw (321) in the directions indicated by arrow A. Loosening the set screw (321) allows the interface (102) to disengage from the vertical support (101) and move freely in the Z directions (250) closer to and further away from the substrate (150) as indicated in FIGS. 4 and 3, respectively. In another example, the set screw (321) may be disengaged by pulling the set screw (321) in the Y direction away from the vertical support (101) against, for example, a spring force applied to the set screw (321). Accordingly, when released, the spring force draws the set screw (321) into the vertical support (101), thus engaging with the vertical support (101) to retain the interface (102) in a particular position.

FIGS. 3 and 4 also depict a shim (160) that may be used to position the interface (102) a desired distance away from the substrate (150) which distance may be referred to as a dispensing distance. In one example, the shim (160) may be removably coupled to the fluid ejection system (200) such as, for example, the top of the vertical support (101) in order to help ensure that the shim (160) is not misplaced. In this example, when not in use, the shim (160) may be coupled in a recess (161) defined in the vertical support (101). The shim (160) may be removably coupled to the vertical support (101) using any mechanical device including, for example, a magnet. In this example, the shim (160) or a portion of the shim (160) includes a magnetic material that is attracted to a portion of the recess (161) that also includes a magnetic material. In another example, the shim (160) may be held within the recess (161) using an interference fit where sizing tolerances of the shim (160) and recess (161) create sufficient friction between the walls of the recess (161) and the shim (160) to hold the shim (160) within the recess (161), but allow a user to draw the shim (160) out of the recess (161).

In use, the shim (160) may be removed from the recess (161) by a user, and the user may place the shim (160) on top of the substrate (150). With the interface (102) disengaged from the vertical support (101) using the set screw (321) or any other mechanical adjustment device (FIG. 1, 120), the interface (102) may be lowered to rest on the shim (160). The shim (160) may be sized to place the interface (102), and installed ejection head (103), a desired distance away from the substrate (150). In one example, the shim (160) may have a thickness of approximately 1.5 mm. However, any distance may be defined by the shim (160). In some examples, multiple shims (160) may be used simultaneously to determine the dispensing distance. In this example, each shim (160) may define incremental distances that may be used to define the dispensing distance, or may be used in any combination to obtain any the desired dispensing distance.

While, examples have been provided describing the placement of a shim (160) between the interface (102) and the substrate (150), in some examples, the shim (160) may be place between other components. For example, the shim (160) may be placed between the substrate (150) and the substrate mount (155) and between the substrate mount (155) and the substrate stage (151).

Once the desired dispensing distance between the interface (102) and the substrate (150) has been set, for example via the shim (160), the user may re-engage the set screw (321) at the desired position. Engaging the set screw (321) mechanically couples the interface (102) to the vertical support (101) at that position and holds the interface (102) fixed in the Z direction. The ejection of fluids from the ejection head (103) may then be performed by moving the substrate stage (151) relative to the base (152) in the X and Y directions to place the substrate (150) in a desired location underneath the ejection head (103). For example, wells of a titration plate may be aligned with corresponding fluidic die on the underside of the ejection head (103). Further, when a shim (160) is used, the shim (160) may be secured within the recess (161) in order to stow and retain the shim (160).

In summary, the interface (102) described herein may be positioned relative to the substrate (150) to provide delivery of fluid to a predetermined portion of the substrate (150). The interface (102) being moveable relative to the substrate (150) allows for adjustment of a spacing between the ejection head (103) and substrate (150) so as to ensure effective fluidic ejection. Were the interface (102) too far from the substrate (150), the fluid dispensed from the ejection head (103) may mis-eject the fluid onto a wrong location on the substrate (150). As a specific example, the fluid may be deposited in different well of a titration plate than what was desired/expected. This may create significant errors in the chemical and biological processes and reactions performed. Therefore, the systems and methods described herein help to ensure that the correct fluids are deposited on a correct and intended location on the substrate (150), for example within a correct and intended well of a titration plate.

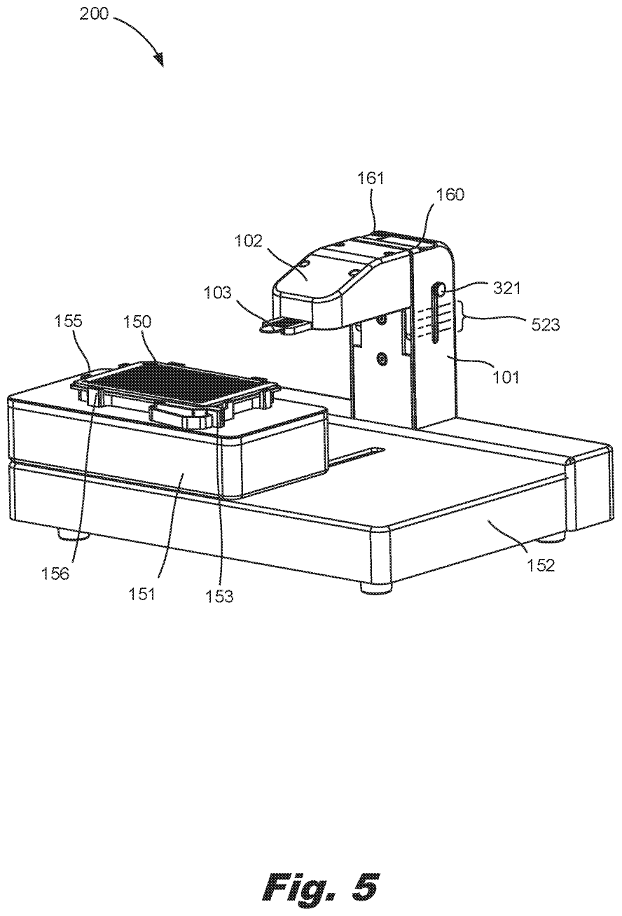

FIG. 5 is an isometric view of the fluid ejection system (200) with a set screw (321) adjustment device and preset position indicators (523), according to an example of the principles described herein. FIG. 5 depicts certain elements of the fluid ejection system (200) similar to those described above such as the base (152), substrate stage (151), and a substrate mount (155) with locating features (156) and a spring-loaded retention device (153) to retain the substrate (150) to the substrate stage (151). FIG. 5 also depicts the vertical support (101), interface (102) with an ejection head (103) disposed therein, as well as the shim (160) as stowed in a recess (161). As with the examples depicted in FIGS. 3 and 4, in this example, the manual adjustment device (FIG. 1, 120) is a set screw (321) which selectively engages the interface (102) with the vertical support (101).

In the example depicted in FIG. 5, the fluid ejection system (200) further includes a number of preset position indicators (523). The preset position indicators (523) may be physical markings on the vertical support (101) next to the set screw (321) that indicate discrete dispensing distances between the interface (102) and the substrate (150). Accordingly, a user may adjust the set screw (321) to the positions indicated by the preset position indicators (523) to obtain a desired dispensing distance. In one example, the preset position indicators (523) includes a number of lines and values indicating the dispensing distances of the lines.

The system may include a number of mechanical stops that correspond to the preset position indicators (523). Such mechanical stops may provide haptic feedback to indicate to a user that a particular dispensing distance has been selected. For example, the stops may include detents defined along a length of the rails used to mechanically and movably couple the interface (102) to the vertical support (101). The detents may provide mechanical, haptic feedback to the user as the user disengages the set screw (321) and moves the interface (102) in the Z direction. That is, the user may feel the detents, and engage the set screw (321) once a desired detent is reached. In one example, the set screw (321) may include a spring that biases the set screw (321) towards the rails and into the detents along the length of the rails. In this example, the user may disengage the set screw (321) by overcoming the spring force provided by the spring, and move the interface (102) relative to the vertical support (101) until the user feels that the set screw (321) has engaged with a detent. The detents together with the preset position indicators (523) allow the user to visually identify and precisely set a desired dispensing distance.

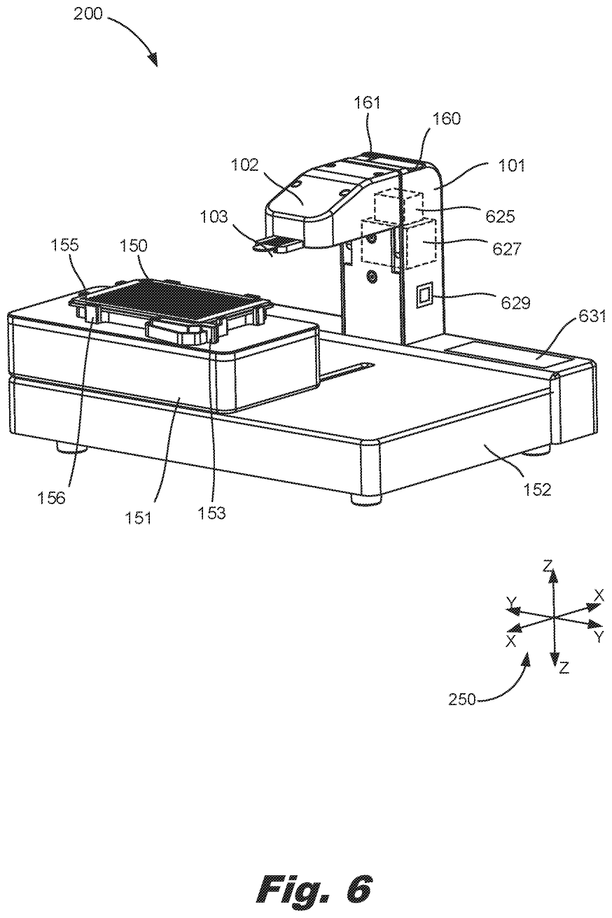

While FIGS. 3-5 depict a fluid ejection system (200) with a set screw (321) as the manual adjustment device (FIG. 1, 120), any number of manual adjustment devices (FIG. 1, 120) may be used in connection with the movement and securing of the interface (102) relative to the vertical support (101). For example, FIG. 6 is an isometric view of the fluid ejection system (200) with a motor (625) and gear set (627) adjustment device, according to an example of the principles described herein. The fluid ejection system (200) depicted in FIG. 6, includes elements similar to those included in the examples depicted in FIGS. 3-5, and description of these elements are provided in connection with those figures.

In the example depicted in FIG. 6, a gear set (627) mechanically couples the interface (102) to the motor (625), and the motor (625) may be coupled to the vertical support (101). When activated, the motor (625) drives the gear set (627) to move the interface (102) relative to the vertical support (101).

In one example, the motor (625) is activated using a toggle switch (629). The toggle switch (629) may include an up-movement position and a down-movement position indicating movement of the interface (102) upwards and downwards, respectively. Activation of the toggle switch (629) moves the interface (102) in the indicated direction. In this manner, the user may use the toggle switch (629) to move the interface (102) closer to, or farther away from, the substrate (150).

In one example, the fluid ejection system (200) may include a graphical user interface (GUI) (631). The GUI (631) may display various pieces of information including Information regarding the position of the interface (102) relative to the substrate (150) and/or the vertical support (101). In one example, this information may include an indication of distance in, for example, millimeters. In some examples, the GUI (631) may also include a field in which a user may enter a desired dispensing distance. In this example, the motor (625) may actuate to move the interface (102) to a position corresponding to the desired dispensing distance. In another example, the GUI (631) allows for entry of a type of substrate (150), such as different types of titration plates, that is placed on the substrate stage (151). The type of substrate (150) may define the dispensing distance between the interface (102) and the substrate stage (151). For example, titration plates from different manufacturers may have varying or different heights. Thus, the GUI (631) may be used to account for the different heights of the different titration plates. In response to entry of the type of substrate (150) in the GUI (631), the motor (625) activates to move the interface (102), and inserted ejection head (103), relative to the vertical support (101) to the distance represented by the type of substrate (150) selected. While FIG. 6 depicts the GUI (631) as being disposed on the base (152), the GUI (631) may be another type of interface, such as an interface on a tablet or other computing device.

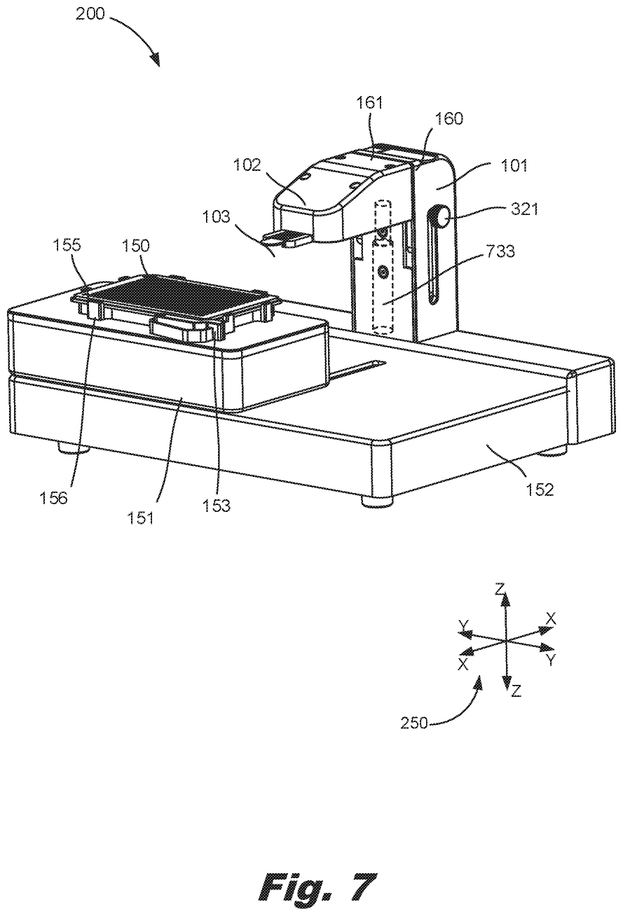

FIG. 7 is an isometric view of the fluid ejection system (200) with a pneumatic adjustment device (733), according to an example of the principles described herein. The fluid ejection system (200) depicted in FIG. 7, includes elements similar to those included in the examples depicted in FIGS. 3-5, and description of these elements are provided in connection with those figures. In the example depicted in FIG. 7, the pneumatic adjustment device (733) assists a user in moving the interface (102) relative to the vertical support (101). Disengagement of the pneumatic adjustment device (733) allows the interface (102) to move relative to the vertical support (101), and engagement of the pneumatic device (733) holds the interface (102) at a position relative to the vertical support (101).

In this example, one end of the pneumatic adjustment device (733) is coupled to the vertical support (101), and the other end of the pneumatic adjustment device (733) is coupled to the interface (102). Accordingly, the user may disengage the set screw (321), and rather than allowing the dispense head (102) move freely relative to the vertical support (101), the pneumatic adjustment device (733) dampens the movement of the interface (102). This allows the user to move the interface (102) without fear that the interface (102) will simply drop and potentially be damaged. The pneumatic adjustment device (733) may be a pneumatic cylinder that uses compression and/or release of a fluid or gas to move one end of the pneumatic adjustment device (733) relative to the other.

In summary, in the examples described herein, the set screw (321), shim (160), motor (625), gear set (FIG. 6, 627), toggle switch (FIG. 6, 629), GUI (FIG. 6, 631), preset position indicators (FIG. 5, 523), pneumatic adjustment device (733), and combinations move the interface (102) relative to the vertical support (101) in order to achieve a desired dispensing distance between the substrate (150) and the interface (102). As described above, such components may be used in combination. For example, the motor (FIG. 6, 625) and pneumatic adjustment device (733) may be used together such that the motor (625) controls the amount of fluid or gas entering the pneumatic adjustment device (733) to actuate the pneumatic adjustment device (733) and, in turn, move the interface (102).

Accordingly, the systems and methods described herein provide a high-precision system for dispensing fluids onto a substrate (150) that is less complex and thus less costly to manufacture, without sacrificing precision of fluid ejection. This creates a more effective and efficient product for users of fluid ejection systems (200).

The preceding description has been presented to illustrate and describe examples of the principles described. This description is not intended to be exhaustive or to limit these principles to any precise form disclosed. Many modifications and variations are possible in light of the above teaching.

What is claimed is:

1. A fluid ejection device comprising:
a vertical support;
an interface movably coupled to the vertical support, the interface to receive an ejection head; and
a manual adjustment device associated with the interface to adjust a distance between the interface and a substrate stage.

2. The fluid ejection device of claim 1, wherein:
the manual adjustment device comprises a set screw coupled between the interface and the vertical support;
disengagement of the set screw disengages the interface from the vertical support to allow the interface to move relative to the vertical support; and
engagement of the set screw holds the interface at a position relative to the vertical support.

3. The fluid ejection device of claim 2, further comprising a number of preset position indicators for the set screw, the number of preset position indicators defining a number of dispensing distances between the interface and the substrate stage.

4. The fluid ejection device of claim 1, further comprising a shim removably coupled to the fluid ejection device for placement between the interface and a substrate on the substrate stage, wherein a thickness of the shim defines a distance between the interface and the substrate.

5. The fluid ejection device of claim 1, wherein the manual adjustment device comprises:
a motor; and
a number of gears driven by the motor and coupled between the vertical support and the interface, the number of gears to move the interface relative to the vertical support.

6. The fluid ejection device of claim 5, further comprising:
a graphical user interface (GUI) to receive a value defining the distance between the interface and the substrate stage,
wherein, in response to entry of the value in the GUI, the motor is to move the interface relative to the vertical support to the distance represented by the value.

7. A fluid ejection system comprising:
a base;
a substrate stage movably coupled to the base;
a fluid ejection device comprising:
a vertical support extending from the base;
an interface movably coupled to the vertical support; and
a manual adjustment device associated with the interface to adjust a distance between the dispenser interface and the substrate stage; and
an ejection head disposed in the interface to hold and eject fluid to be dispensed onto a substrate.

8. The fluid ejection system of claim 7, wherein:
the manual adjustment device comprises a set screw coupled between the interface and the vertical support;
disengagement of the set screw allows the interface to move relative to the vertical support; and
engagement of the set screw holds the interface at a position relative to the vertical support.

9. The fluid ejection system of claim 8, further comprising a number of preset position indicators for the set screw, the number of preset position indicators defining a distance between the interface and the substrate stage.

10. The fluid ejection system of claim 7, further comprising a shim removably coupled to the fluid ejection device for placement between the interface and a substrate disposed on the substrate stage, wherein a thickness of the shim defines a distance between the interface and the substrate.

11. The fluid ejection system of claim 7, wherein:
the manual adjustment device comprises a pneumatic device coupled between the interface and the vertical support;
disengagement of the pneumatic device allows the interface to move relative to the vertical support; and
engagement of the pneumatic device holds the interface at a position relative to the vertical support.

12. A fluid ejection system comprising:
a base;
a substrate stage movably coupled to the base;
a substrate disposed on the substrate stage; and
a fluid ejection device comprising:
a vertical support extending from the base;
an interface movably coupled to the vertical support; and
a manual adjustment device associated with the interface to adjust a distance between the dispenser interface and the substrate; and
an ejection head disposed in the interface to hold and eject fluid to be dispensed onto the substrate.

13. The fluid ejection system of claim 12, wherein the manual adjustment device comprises:
a motor; and
a number of gears driven by the motor and coupled between the vertical support and the interface, the number of gears to move the interface relative to the vertical support.

14. The fluid dispensing system of claim 13, further comprising:
a toggle switch to, when activated, adjust the distance between the interface and the substrate stage,
wherein, in response to activation of the toggle switch, the motor moves the interface relative to the vertical support.

15. The fluid dispensing system of claim 13, further comprising:
a graphical user interface (GUI) to receive entry of a type of the substrate, the type of substrate defining the distance between the interface and the substrate stage,
wherein, in response to entry of the type of the substrate, the motor moves the interface relative to the vertical support to the distance defined by the type of substrate.
